(19) United States
(12) Patent Application Publication
(10) Pub. No.: US 2004/0014446 A1
(43) Pub. Date: Jan. 22, 2004

(54) Methods and systems for odd-order LO compensation for even-harmonic mixers

(76) Inventors: Sudipto Chakraborty, Atlanta, GA (US); Babak Matinpour, Atlanta, GA (US); Joy Laskar, Atlanta, GA (US)

Correspondence Address: NORA M. TOCUPS, P.O BOX 698, 140 PINECREST AVE, DECATUR, GA, 30030, US

(21) Appl. No.: 10/431,925

(22) Filed: May 8, 2003

Related U.S. Application Data
(60) Provisional application No. 60/378,796, filed on May 8, 2002.

(51) Int. Cl. H04B 17/00

(52) U.S. Cl. 455/226.4; 455/249.1

(57) ABSTRACT

A higher frequency modulator built with low cost materials and with a lower power requirement is described as well as methods relating thereto. A received radio frequency (RF) signal is combined with a created local oscillator (LO) signal to result in a combined radio frequency (RF) signal, which may be converted into a message signal. A subharmonic mixer may be used to convert the combined RF signal into the message signal. The subharmonic mixer may include antiparallel diode pair (APDP) topology. The created LO signal is a combination of a selected LO signal with another LO signal. The selected LO signal may be a subharmonic of the RF signal. The other LO signal may be a low odd-order harmonic of the selected LO signal. Preferably, the created LO signal is not greater than the RF signal.

### CROSS-REFERENCE TO RELATED APPLICATION

The present application claims priority to and benefit of the prior filed co-pending and commonly owned provisional application, filed in the United States Patent and Trademark Office on May 8^{th}, 2002, assigned Application No. 60/378,796, and incorporated herein by reference.

### FIELD OF THE INVENTIONS

The inventions relate to electrical signal modulator and demodulator circuits having harmonic or subharmonic mixers.

### BACKGROUND

Cell phones, personal communications networks and other wireless communications are growing more and more popular and causing an increased demand on the presently allocated frequency bands in the electromagnetic spectrum. With this explosive growth in over-the-air communications, channels are being reallocated to higher and higher frequency bands. This creates a great need to provide improved electronic circuits capable of operating at higher frequencies with low dB loss.

A modulator circuit is one common piece of communications equipment that has to be redesigned to operate at these higher frequencies. A modulator is used to shift the frequency of a slow varying or lower frequency input signal to a higher frequency for transmission. This frequency shifting is accomplished most commonly by mixing a high frequency local oscillator (LO) or carrier signal with an intermediate frequency (IF) or modulation signal. The mixing produces a modulated output signal having a frequency typically at the sum and the difference of the carrier signal frequency and modulation signal frequency.

Most of the modulators in use today are expensive to use for high frequency applications. One reason is the dramatic increase in costs associated with providing the electronic components designed for processing signals at higher frequencies. In fact, doubling the frequency of the carrier signal may more than double the cost of one or more of the modulator's components. Another cost increase occurs when additional components are necessary to achieve the proper amplitude and phase balance of signals within the modulator circuit at the higher frequencies.

There are many different types of mixing techniques used for these modulator circuits. Since the higher frequencies are being used, subharmonic mixing techniques, which were historically used for millimeter-wave applications, are no longer strangers to mainstream wireless applications such as cell phones and wireless local area network (WLAN) systems. Subharmonic passive mixers that exhibit excellent linearity performance are becoming even more attractive for the next generation wireless hardware. One difficulty, however, in integrating passive mixers on chip is the requirement of high LO power. This requirement leads to significant problems through radiation and substrate coupling, and also increases the power consumption of the LO buffers. The requirement also adds to the expense, as discussed above.

Within the past decade, an antiparallel diode pair has been used to build modulator circuits with subharmonic LOs. In these prior art devices, however, the passive mixers focus only on the 2nd subharmonic operation, which may be suitable for low RF input frequencies, up to 6 GHz. As the RF frequency gets higher, on-chip integration of high quality oscillators becomes difficult. This provides the motivation to investigate techniques that allow the mixer core to operate at higher subharmonics (lower LO frequencies). But the conversion loss and linearity performances achieved by application of single tone LO operating at 4th and 8th subharmonics are not very attractive as their contribution is less significant compared to the 2nd order subharmonic LO tone.

Therefore, there is a need for a higher frequency modulator that is built with low cost materials and has a low power requirement. Subharmonic mixers are excellent modulators, but at high frequencies, they typically have required very high LOs. This presents the need for a technique to achieve the same subharmonic mixing with a low level LO.

### SUMMARY OF THE INVENTIONS

The inventions satisfy the need for a higher frequency modulator that may be built with low cost materials and has a low power requirement. Generally stated, the inventions involve a novel mixing technique that includes local oscillator (LO) harmonic(s) to reduce the main subharmonic LO frequency and reduce the LO power requirement. The inventions improve performance by the inclusion of the third, or other low odd multiple, harmonic tone of the higher order subharmonic LO frequency under application (such as the 4^{th} or 8^{th} subharmonics). Combining tones also helps reduce the LO power level requirement on the individual tones, thus favoring on-chip integration of such mixers for wireless transceiver applications. The inventions include the technique referred to as “odd order LO compensation” and exhibit lower conversion loss and higher linearity compared to the 2^{nd} subharmonic operation of previous passive mixers.

An exemplary embodiment of the inventions is a method for operating a high frequency modulator. A received radio frequency (RF) signal is combined with a created LO signal to result in a combined RF signal, which may be converted into a message signal. A subharmonic mixer may be used to convert the combined RF signal into the message signal. The subharmonic mixer may include antiparallel diode pair (APDP) topology.

The created LO signal is a combination of a selected LO signal with another LO signal. The selected LO signal may be a subharmonic of the RF signal. The other LO signal may be a low odd-order harmonic of the selected LO signal. Preferably, the created LO signal is not greater than the RF signal.

Another exemplary embodiment is a method for creating a modulated radio frequency (RF) signal. Per this method, a local oscillator (LO) signal is selected with respect to a radio frequency (RF) signal. The LO signal may be a subharmonic of the RF signal. Another LO signal also is selected. The other LO signal may be a low odd-order LO signal. The LO signal and the other LO signal are combined into a created LO signal. The created LO signal may not be greater than the RF signal. The created LO signal is combined with the RF signal into the combined RF signal.

Yet another exemplary embodiment of the inventions is a modulator for creating a modulated radio frequency (RF) signal. The modulator includes a first combiner used to combine a selected local oscillator (LO) signal with another LO signal into a created LO signal. The selected LO signal may be a subharmonic of the RF signal. The other LO signal may be a low odd-order harmonic of the selected LO signal. The created LO signal may not be greater than the RF signal. The modulator also includes a second combiner used to combine the created LO signal with a radio frequency (RF) signal into a combined RF signal. The modulator may include a subharmonic mixer having antiparallel diode pair (APDP) topology for converting the combined RF signal into a message signal.

The advantages of the inventions may be more clearly understood and appreciated from a review of the following detailed description of exemplary embodiments and by reference to the appended drawings and claims.

### BRIEF DESCRIPTION OF THE DRAWINGS

FIG. 1 is a block diagram of an exemplary environment for the inventions.

FIG. 2 is a flow diagram of some actions taken by an exemplary embodiment of the inventions.

FIG. 3A is a circuit diagram of an exemplary embodiment of the inventions.

FIG. 3B is another circuit diagram of another exemplary embodiment of the inventions.

### DETAILED DESCRIPTION

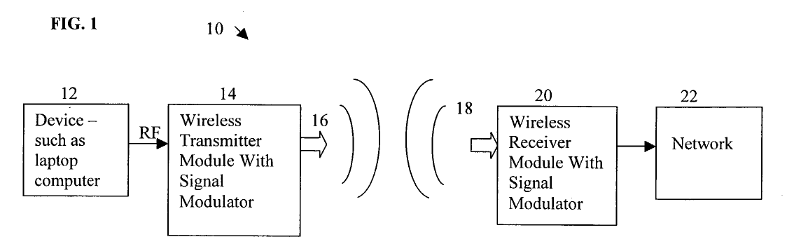

FIG. 1 is a conceptual illustration of one possible application of signal modulators in a Wireless Local Area Network (WLAN) 10. In order for a device, such as a laptop computer 12, to communicate via a wireless system to a computer network 22, an RF signal is sent from the device 12 and then modulated with a signal modulator 14. The modulated RF signal may be converted to a message signal, which is then transmitted with an antenna 16. The receiving antenna 18 receives the message signal and converts it into the modulated RF signal. The modulated RF signal then may be demodulated with a signal modulator 20 (also referred to as a demodulator) and sent on to the computer network 22.

Referring to FIG. 1, the modulator circuit (also referred to as a transmitter module, a signal modulator, or a modulator) 14 is used to modify (also referred to as modulate) an RF signal for transmission at a different frequency. As noted in the background, due to the popularity of wireless devices, such transmissions are generally being forced to higher and higher frequencies.

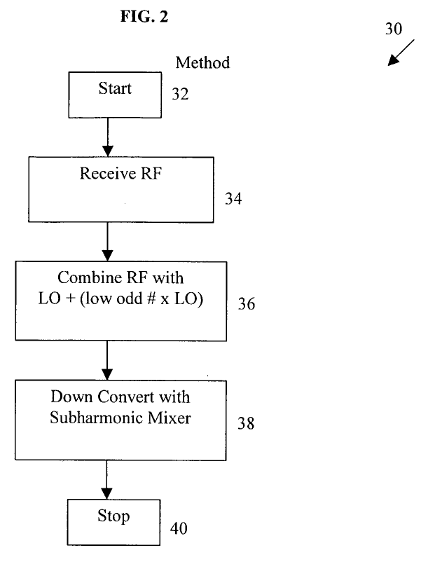

FIG. 2 is a flowchart showing actions of an exemplary method 30 pursuant to the inventions for modulating an RF signal. As in conventional RF signal modulation, the RF signal in the exemplary embodiment is combined with a local oscillator (LO) signal (also referred to as a carrier signal or LO). The combined RF signal then may be down-converted for transmission. In the exemplary embodiment, the RF signal is combined with a “created LO signal” as is explained below to result in a combined (also referred to as modified) RF signal.

Referring to FIG. 2, after start 32, the RF signal (also referred to as RF) is received in action 34. The RF signal then is combined with a created LO signal so as to result in a combined RF signal in action 36. The created LO signal is a combination of a selected LO signal (typically a subharmonic of the RF signal) and a low odd-order harmonic signal of the selected LO signal. For ease of reference, a low odd-order harmonic signal of the selected LO signal is referred to herein as a low odd-order LO signal. In other words, the created LO signal is a combination of the selected LO signal and the low odd-order LO signal. Further, the created LO signal is not greater than the RF signal. The exemplary process of creating the created LO signal and combining it with the RF signal may be referred to as odd-order LO compensation. Advantageously, the result of the modulation of the RF signal with the created LO signal is a modulated RF signal.

In action 38, the modulated RF signal may be down-converted, such as by a subharmonic mixer, in action 38. The exemplary method ends in action 40.

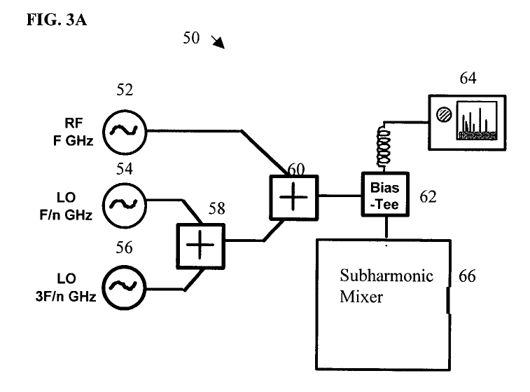

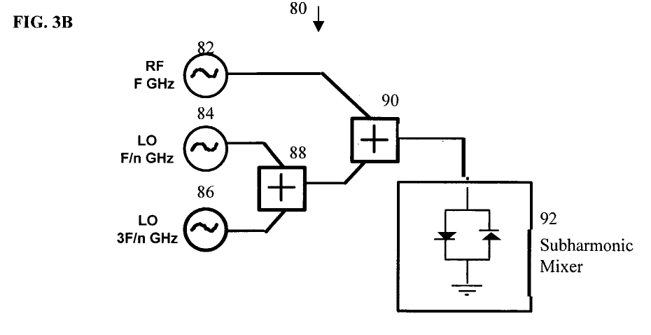

FIG. 3A is a circuit diagram 50 of an exemplary embodiment of the inventions. As inputs, the diagram illustrates an RF signal 52 in F GHz (where “F” is frequency); a selected LO signal 54 in F/n GHz (where “F/n” represents a sub-harmonic frequency of the RF signal 52); and a low odd-order LO signal 56, which is a low odd-order harmonic frequency of the selected LO signal 54. In the exemplary circuit 50, the, low odd-order harmonic frequency of the LO signal 56 is selected as 3F/n GHz.

As further illustrated in FIG. 3A, the selected LO signal 54 is combined with the low odd-order LO signal 56 to result in a created LO signal 58. In the example, the selected LO signal 54 is combined with the low odd-order signal 56, whose frequency is three times that of the selected LO signal 54, to create the created LO signal 58. Preferably, the frequency of the created LO signal 58 is not greater than the frequency of the RF signal.

FIG. 3A also illustrates that the RF signal 52 is combined with the created LO signal 58 to result in the combined RF signal 60. The combined RF signal 60 then may be entered into a mixer 66 to create a converted signal, or message signal suitable for transmission. In this exemplary embodiment, the mixer 66 is a subharmonic mixer to down-convert the signal. Advantageously, the described odd-order LO compensation results in a lower frequency, lower power LO.

FIG. 3A further illustrates an exemplary use of optional measuring equipment in connection with the circuit illustrated as circuit diagram 50. For example, optional bias-tee 62 may be connected in the circuit so that the combined RF signal 60 passes through the bias-tee 62 before entering the mixer 66. The bias-tee 62 interfaces with optional measuring equipment 64.

FIG. 3B is a schematic for a modulator circuit 80 using odd-order LO compensation with a subharmonic mixer, shown as an exemplary anti-parallel diode pair (APDP) topology.

As in the circuit of FIG. 3A, there are three inputs in the circuit 80: an RF signal 82 with F Gz; a selected LO signal 84 with F/n GHz; and a low odd-order LO signal 86 with 3F/n GHz. The selected LO signal 84 is combined with the low odd-order LO signal 86 to create the created LO signal 88. As in the example described in connection with FIG. 3A, the created LO signal is a combination of: the selected LO signal 84, which is a subharmonic of the RF signal; and the low odd-order LO signal 86, which, as its name implies, is a low-value odd-order subharmonic of the selected LO signal. Preferably, the combination of the selected LO signal 84 and the low odd-order LO 86 does not exceed the original RF signal.

Still referring to FIG. 3B, the RF signal 82 is combined with the created LO signal 88 to result in the combined RF signal 90. This combined signal 90 may then be entered into a mixer 92. In this exemplary embodiment, the mixer 92 is a subharmonic mixer. Advantageously, the low odd-order LO compensation technique creates a modified (also referred to as combined) RF signal that is well suited for transmission at higher frequencies.

Referring to FIG. 3B, an antiparallel diode pair (APDP) topology is used for the subharmonic mixer 92 in the exemplary embodiment. The inventions are not limited to the use of an APDP subharmonic mixer.

The inventions have been disclosed by way of example and it will be understood that other modifications may occur to those skilled in the art without departing from the scope and the spirit of the appended claims.

We claim:

1. A method for operating a high frequency modulator, comprising:
receiving a radio frequency (RF) signal;
combining a selected LO signal with another LO signal to create a created LO signal;
combining the created LO signal and the RF signal to result in a combined RF signal; and
converting the combined RF signal into a message signal.

2. The method of claim 1, wherein the created LO signal is not greater than the RF signal.

3. The method of claim 1, wherein the selected LO signal comprises a subharmonic of the RF signal.

4. The method of claim 1, wherein the another LO signal comprises an odd-order harmonic of the selected LO signal.

5. The method of claim 4, wherein the odd-order harmonic of the selected LO signal comprises a low odd-order harmonic of the selected LO signal.

6. The method of claim 1, wherein converting the combined RF signal into the message signal comprises using a subharmonic mixer to convert the combined RF signal into the message signal.

7. The method of claim 6, wherein the subharmonic mixer comprises antiparallel diode pair (APDP) topology.

8. A method for creating a combined radio frequency (RF) signal, comprising:
selecting a local oscillator (LO) signal with respect to a radio frequency (RF) signal;
selecting another LO signal;
combining the LO signal and the another LO signal into a created LO signal; and
combining the created LO signal with the RF signal into the combined RF signal.

9. The method of claim 8, further comprising:
providing that the LO signal comprises a subharmonic of the RF signal.

10. The method of claim 8, further comprising:
providing that the another LO signal comprises an odd-order LO signal.

11. The method of claim 10, further comprising:
providing that the odd-order LO signal comprises a low odd-order LO signal.

12. The method of claim 8, further comprising:
providing that the created LO signal is not greater than the RF signal.

13. A modulator for creating a modulated radio frequency (RF) signal, comprising:
a first combiner operative to combine a selected local oscillator (LO) signal with a another LO signal into a created LO signal; and
a second combiner operative to combine the created LO signal with a radio frequency (RF) signal into a combined RF signal.

14. The modulator of claim 13, further comprising:
a mixer for converting the modulated RF signal into a message signal.

15. The modulator of claim 14, wherein the mixer comprises a subharmonic mixer.

16. The modulator of claim 12, wherein the mixer comprises antiparallel diode pair (APDP) topology.

17. The modulator of claim 13, wherein the selected LO signal comprises a subharmonic of the RF signal.

18. The modulator of claim 13, wherein another LO signal comprises an odd-order harmonic of the selected LO signal.

19. The modulator of claim 18, wherein the odd-order harmonic of the selected LO signal comprises a low odd-order harmonic of the selected signal.

20. The modulator of claim 13, wherein the created LO signal is not greater than the RF signal.
